(19) United States
(12) Patent Application Publication
(10) Pub. No.: US 2014/0318664 A1
(43) Pub. Date: Oct. 30, 2014

(54) Non-Kinking Fluid Delivery Hose

(71) Applicants: ROBERT BOSCH GMBH, Stuttgart (DE); ROBERT BOSCH TOOL CORPORATION, Broadview, IL (US)

(72) Inventors: Joseph Mayher, New Kensington, PA (US); Charles A. Lehmann, Metamora, IL (US)

(73) Assignees: ROBERT BOSCH GMBH, Stuttgart (DE); ROBERT BOSCH TOOL CORPORATION, Broadview, IL (US)

(21) Appl. No.: 14/211,226

(22) Filed: Mar. 14, 2014

Related U.S. Application Data
(60) Provisional application No. 61/787,398, filed on Mar. 15, 2013.

(51) Int. Cl. F16L 27/08

(52) U.S. Cl. CPC F16L 27/0861
USPC 138/155

(57) ABSTRACT

A non-kinking fluid delivery hose includes a plurality of intermediate hose segments between end hose segments, each of said intermediate hose segments having a respective end portion and a substantially uniform length among the plurality of hose segments. A swivel coupling connects two adjacent hose segments, the coupling including a pair of engagement elements configured for fluid tight engagement with an end portion of a respective one of the adjacent hose segments and a swivel element engaged between the pair of engagement elements configured to permit relative rotation between the engagement elements and defining a passageway therethrough fluidly connecting the adjacent hose segments. The swivel coupling allows the adjacent hose segments to swivel or rotate relative to each other to thereby preventing kinking of the hose as it is uncoiled.

### REFERENCE TO RELATED APPLICATION AND PRIORITY CLAIM

This application is a non-provisional of and claims priority to co-pending provisional application No. 61/787,398, filed on Mar. 15, 2013, the disclosure of which is incorporated herein in its entirety.

### TECHNICAL FIELD

is disclosure relates to fluid-delivery hoses, such as garden hoses, pressure hoses, pneumatic hoses and the like, and particularly to features for preventing kinking or coiling of the hose during use.

### BACKGROUND

Fluid delivery hoses are typically tubular bodies in which the tubular shape is dictated by strength requirements so that the hose will not burst or leak when pressurized fluid flows therethrough. Although the typical hose is relatively flexible, the hose substantially retains its tubular shape when being stored. In most cases the hose is coiled for storage for a few reasons, such as coiling provides a compact envelop and coiling allows the hose to be quickly deployed or unwound. However, due to the nature of the hose material (which is typically rubber or a soft plastic such as a vinyl plastic) a coiled hose has a tendency to retain a certain amount of coil even when being deployed. Moreover, many hoses have a tendency to kink when being deployed, especially when the hose is being extended before fluid is flowing through it. A kink in a hose obviously compromises the fluid flow through the hose. Partial coiling of a deployed hose may not necessarily restrict fluid flow, but this effect can inhibit full deployment of the hose.

There is a need for a fluid delivery hose that avoids or eliminates kinking and partial coiling during use. The hose must remain fluid tight and generally immune to leakage or bursting.

### SUMMARY

According to one aspect, a non-kinking fluid delivery hose is provided with a plurality of intermediate hose segments between end hose segments, each of said intermediate hose segments having a respective end portion and a substantially uniform length among the plurality of hose segments. A swivel coupling connects two adjacent hose segments, the coupling including a pair of engagement elements configured for fluid tight engagement with an end portion of a respective one of the adjacent hose segments and a swivel element engaged between the pair of engagement elements configured to permit relative rotation between the engagement elements and defining a passageway therethrough fluidly connecting the adjacent hose segments. The swivel coupling allows the adjacent hose segments to swivel or rotate relative to each other to thereby preventing kinking of the hose as it is uncoiled.

The engagement elements may be male or female elements, and may be crimped onto the hose segments. The engagement elements may further be provided with a ferrule for crimping the hose between the ferrule and the engagement element. In one aspect, the swivel coupling includes a pair of circumferential grooves and the engagement elements include a circumferential sealing bead configured for sealing sliding engagement within a groove, thereby providing a sealed engagement that permits relative rotation.

The engagement elements and swivel coupling allows the adjacent hose segments to swivel or rotate relative to each other as the hose is uncoiled. This relative rotation prevents kinking of the hose as it is uncoiled or as it is being maneuvered during use.

### DESCRIPTION OF THE FIGURES

FIG. 1 is a representation of a segment of a fluid delivery hose incorporating the swivel connections of the present disclosure.

FIG. 2 is an enlarged partial cross-sectional view of a female-female swivel connection for use in the hose shown in FIG. 1.

FIG. 3 is an enlarged partial cross-sectional view of a male-male swivel connection for use in the hose shown in FIG. 1.

FIG. 4 is an enlarged view of a crimped engagement between the swivel couplings disclosed herein and a hose segment.

FIGS. 5A-C are a series of views showing the implementation of the swivel connections disclosed herein in a fluid delivery hose being deployed.

FIG. 6 is a cross-sectional view of another swivel coupling disclosed herein.

FIG. 7 is an exploded sectional view of the swivel coupling shown in FIG. 6.

FIG. 8 is an exploded side view of the swivel coupling shown in FIG. 7.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

A fluid delivery hose 10 shown in FIG. 1 incorporates a tubular body 12 of known construction having an end fitting 14 for engagement with a fluid inlet or outlet, for example. The tubular body is formed by a plurality of hose segments 12a, 12b, 12c . . . that are joined by swivel couplings 20. The swivel couplings 20 are configured for fluid tight engagement between adjacent hose segments and to provide a fluid tight flow path through the coupling and between the adjacent segments. The swivel couplings 20 are preferably configured to permit relative rotation R between the adjacent hose segments through a full 360 degrees. Although the hose arrangement shown in FIG. 1 only illustrates couplings along the body of the hose, a swivel coupling may also be integrated into the ends of the hose with the hose end connection joined to a coupling. For instance, a conventional hose connection to a hose bib is in the form of a swivel nut engaging the male threaded bib end. In the typical hose end connection, once the swivel nut is tightened the connection is compressed together so that no further rotation can occur. Including a swivel coupling, such as the coupling 20 disclosed herein, prevents kinking that originates from the ends of the hose. It is further contemplated that the swivel couplings disclosed herein may be engaged to attachments, such as nozzles, sprinklers, etc.

The swivel couplings 20 may be configured as a female-female coupling as depicted in FIG. 2. The coupling 20 includes engagement elements, and particularly female elements 22a, 22b adapted to receive the ends 15a, 15b of the respective hose segments 12a, 12b, and configured for fluid flow therethrough. A fluid-tight engagement is provided between the female element 22a and the end portion 15a of the hose segment 12a. In addition, the engagement between female element and end portion is sufficiently tight that the engagement cannot be disrupted in normal use of the fluid delivery hose 10. For instance, the female element 22a and end portion 15a can be configured for a press-fit engagement, or the female element may be crimped or threaded onto the hose end portion around the entire circumference of the female element. Alternatively, or in addition, an adhesive, epoxy or sealant may be introduced between the end portion 15a and female element 22 to strengthen the engagement and improve the fluid-tight seal. The end 15b of the adjacent hose segment 12b is similarly engaged within the female element 22b of the swivel connection 20.

The swivel coupling 20 is further provided with a swivel element 25 engaged between the female engagement elements 22a, 22b. The swivel element 25 is configured to provide a fluid-tight coupling between the two female elements while also permitting relative rotation between the elements. In one embodiment the female elements may include respective sealing beads 23a, 23b that are slidably disposed within corresponding grooves 26a, 26b defined in the swivel element 25. Rotating seals or bushings (not shown) may be provided within the grooves 26a, 26b, or between the grooves and the sealing beads 23a, 23b of the female elements. The sealing beads and grooves may have complementary shapes to resist disengagement when the beads are disposed within the respective grooves.

The swivel element further defines a central passageway 27 that allows fluid flow therethrough between the coupled hose segments 12a, 12b. In the embodiment illustrated in FIG. 2, the ends 15a, 15b of the hose segments 12a, 12b are offset by a gap 28 from the respective faces 25a, 25b of the swivel element 25. It is desirable that the gap 28 be as small as possible while retaining some offset between the swivel element face and the end of the hose segment to avoid any frictional contact therebetween. The swivel element 25 of FIG. 2 is exemplary of a suitable fluid-tight rotational coupling, but it is understood that other forms of fluid-tight swivel couplings are contemplated.

The swivel coupling may also be in the form of a male-male connection, such as the coupling 20′ shown in FIG. 3. The swivel coupling 20′ includes male engagement elements 22a′, 22b′ that are configured to fit within the respective end portions 15a, 15b of the adjacent hose segments 12a, 12b, and configured for fluid flow therethrough. The swivel coupling 20′ includes a swivel element 25 that may be configured like the swivel element shown in FIG. 2, and specifically including the grooves 26a, 26b. The male elements include respective sealing beads 23a′, 23b′ that are integral with the male elements and configured to be received within a respective groove 26a, 26b in the manner described above. As with the female-female coupling 20, the hose segments 12a, 12b may be provided with a fluid-tight engagement to the male elements of the male-male coupling 20′ in the same manner, such as by crimping, threading, press-fit, epoxy and the like. It is understood that the swivel couplings may also include a male element and a female element for engaging adjacent hose segments.

In the embodiments of FIGS. 2-3 the engagement elements of the couplings 20, 20′ are of the same configuration—i.e., female-female and male-male. It is contemplated that a swivel coupling may be provided with two different engagement elements, namely a female and a male element.

One form of a crimped engagement between a swivel coupling and a hose segment is depicted in FIG. 4. In this embodiment, an inner element 30 includes a ridged or crimped end portion 30a. A mating element 32 may also include a crimped end portion 32a with opposite crimped or ridged surfaces 32b, 32c. An outer ferrule or band 34 is provided that is crimped into tight engagement with the outer surface 32c of the mating element 32. For the female-female connection shown in FIG. 2, the inner element 30 may be a ring pressed into the inner diameter of the hose end, the mating element 32 may be the hose end 15a and the outer ferrule 34 may be the female element 22a of the coupling. For the male-male connection, the male element 22a′ is the inner element 30 and the hose end 15a is the mating element 32, with the outer ferrule 34 being added to the outer surface of the hose end.

Other types of crimped engagement are contemplated that are suitable to achieve a fluid-tight engagement between the swivel coupling and the hose segments. In one application of the crimped engagement shown in FIG. 4, the inner element 30 is a hub, such as the male element 22a′ shown in FIG. 3, and the mating element 32 is the end of a hose segment, such as segment 12a. The crimped portion 30a of the inner element may be pre-formed in the element prior to its introduction into the mating element 32 (i.e., hose segment), or may be formed after the inner element is engaged within the mating element. The crimp in the outer band 34 is preferably formed after the band is engaged around the mating element surface 32c, and may be formed concurrently with the crimp on the inner element end portion 30a. In an alternative configuration, the inner element 30 is the end of a hose segment and the mating element is a hub or female element of the swivel coupling, such as element 22a in FIG. 2. The same crimping protocol may be applied to produce the crimped engagement between the three elements 30, 32 and 34. The outer band 34 is preferably formed of a readily crimpable material that retains its crimped configuration under normal use of the fluid hose. Thus, in one specific embodiment the ferrule or band is formed of brass.

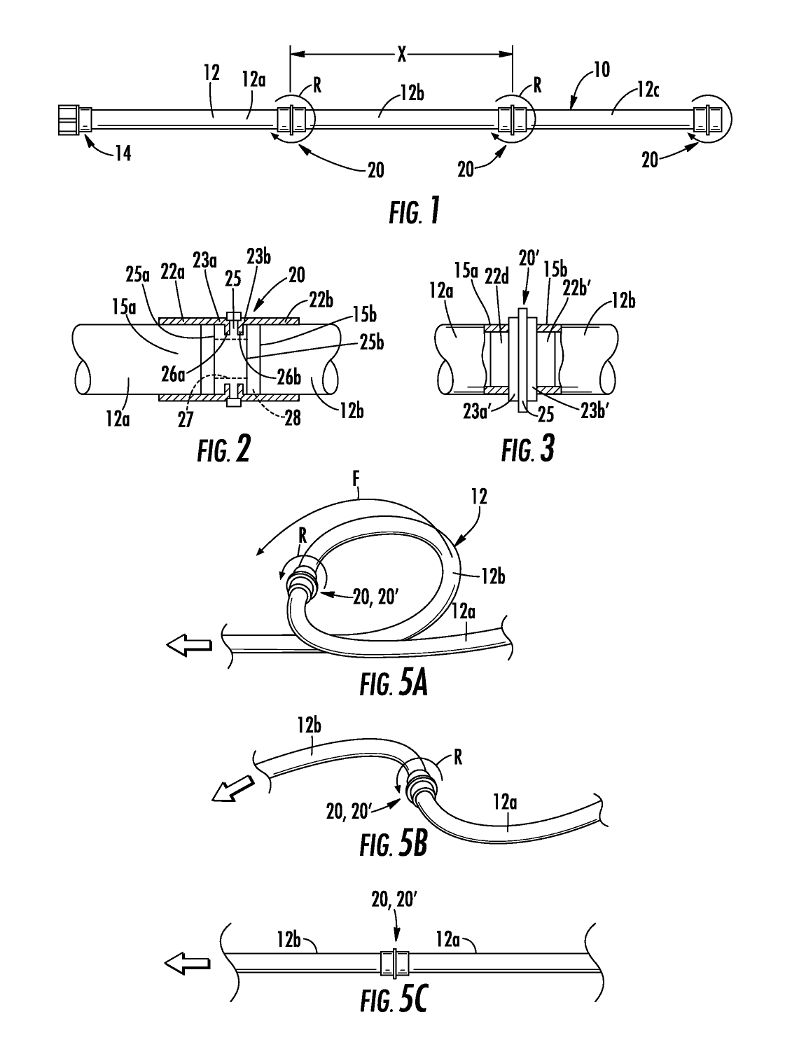

An example of the function of the swivel couplings 20, 20′ is shown in FIGS. 5A-C. In FIG. 5A, the hose 12 is shown partially coiled as may happen when the hose is partially deployed. For a typical hose, further pulling on the hose (as indicated in FIG. 5A) would result in the hose crimping or remaining partially coiled. With the swivel coupling of the present disclosure, further pulling on the hose segment 12b allows the segment to rotate in the direction R at the coupling 20, 20′, and allows the segment 12b to flip in the direction F relative to the adjacent segment 12a, so that the segments are in the configuration shown in FIG. 5B. Further pulling on the hose segment 12b allows further relative rotation R between the adjacent segments until the segments are generally straight, as depicted in FIG. 5C.

The present disclosure contemplates that a plurality of swivel couplings 20, 20′ are evenly spaced along the length of the hose 12, with the couplings uniformly separated by a spacing dimension X (FIG. 1). The spacing dimension X may be calibrated to provide the minimum number of swivel couplings necessary to prevent kinking and partial coiling of the hose 12 during use. In one embodiment, this dimension X may be calibrated to the “natural” coiling diameter of the hose 12, meaning the diameter that the hose can be coiled into without kinking or buckling. The natural coiling diameter is based on the material and construction of the hose. For instance, the construction of a typical ½-⅝ inch diameter garden hose does not allow the hose to be easily coiled at a diameter less than about 18 inches. Consequently, a spacing dimension that is less than 18 inches may not be necessary. For a garden hose of this construction, a spacing dimension of 18-24 inches may provide optimum performance with the fewest number of swivel couplings 20, 20′. For example, a standard 50 ft. garden hose may incorporate 25-30 swivel couplings. The swivel couplings may be spaced farther from the end fittings since the risk of crimping or coiling is minimal at the ends of the hose.

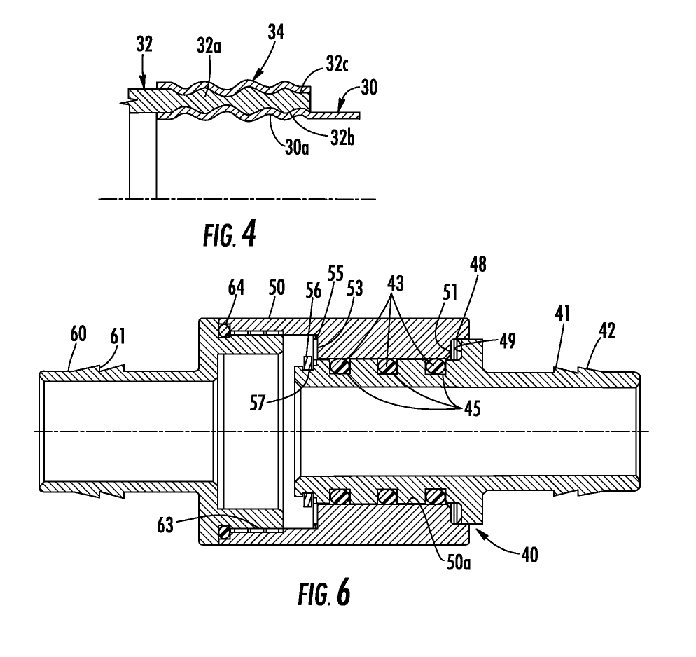

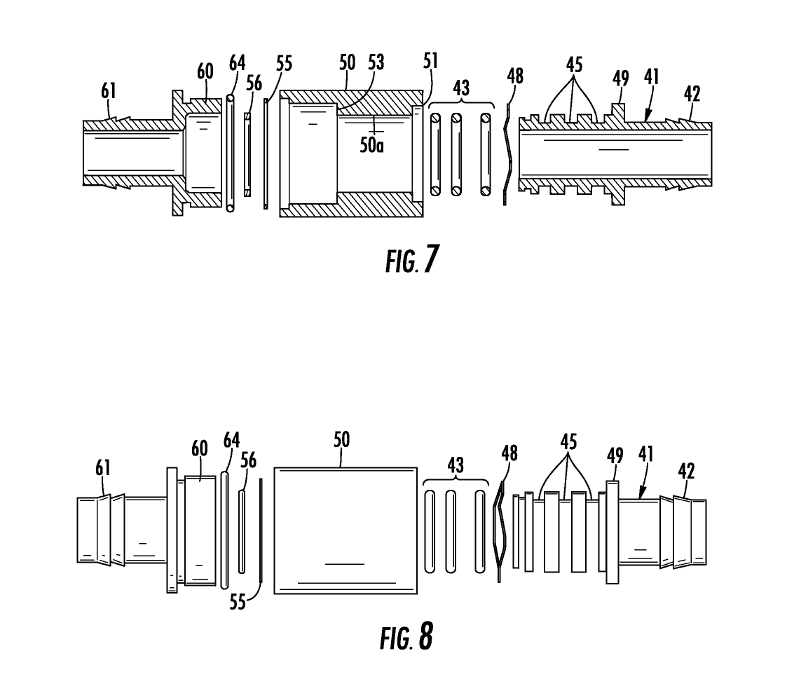

Another swivel coupling 40 is illustrated in FIGS. 6-8 which includes a male shank 41 having a barbed end 42 adapted to be pressed into the end of a hose segment. The male shank 41 defines a series of circumferential grooves 45 for receiving seal rings 43. The male shank is fitted within a coupling body 50 so that the seal rings are in sealed engagement between the grooves 45 and the inner bore 50a of the body. A wave washer 48 or similar circumferential spring element is situated between a flange 49 of the male shank and a shoulder 51 of the coupling body 50. The male shank is held in engagement within the bore 51a of the body by a snap ring 56 engaged within a snap ring groove 57 in the male shank. The snap ring bears against a washer 55 that in turn contacts a shoulder 53 of the coupling body 50. It can be appreciated that the male shank is free to rotate within the coupling body, while the seal rings maintain a fluid-tight seal.

The swivel coupling 40 further includes a female shank 60 having a barbed end 61 for engagement with a hose segment. The female shank may be connected to the coupling body 50 by a threaded engagement 63, with a seal ring 64 compressed between the two components to maintain a fluid-tight seal. The swivel coupling 40 of FIGS. 6-8 can be readily introduced between adjacent hose segments 12a, 12b . . . . One benefit of the swivel coupling 40 is that the barbed ends 42, 61 allow the coupling to be easily retrofitted to an existing hose. In particular, the user simply cuts the hose and connects the two segments to a corresponding barbed end of the coupling. This can be repeated along the length of the hose as desired by the user. In order to ensure a fluid-tight connection at the barbed ends, a hose clamp may be applied to the outer surface of the hose segments coincident with the barbed ends. It can be appreciated that a hose clamp may be beneficial in all the embodiments disclosed herein to ensure a fluid-tight engagement of the swivel couplings to the hose segments.

The swivel couplings may be formed of materials suitable for delivering the same fluids as the hose segments to which they are engaged. The groove and bead interface between the swivel coupling components are preferably formed of a material that can endure several full rotations with each use, while maintaining a fluid-tight seal. For instance, the male/female elements may be formed of a vinyl plastic, while the sealing bead and the swivel element may be formed of brass, DELRIN or other similar low-friction, non-rusting material.

The present disclosure contemplates a fluid delivery hose provided in a plurality of segments along its length, with adjacent segments connected by a swivel coupling that accommodates relative rotation between adjacent segments while permitting continuous leak-free fluid flow therethrough. The swivel couplings may be configured for male or female engagement with the hose segments and are preferably configured to permit full 360 degree relative rotation. The swivel couplings prevent kinking or partial coiling of the hose as it is being deployed or used.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A non-kinking fluid delivery hose comprising:
at least two hose segments, each hose segment having a respective end portion;
a swivel coupling connecting two adjacent ones of said at least two hose segments, said swivel connector including;
a pair of engagement elements configured for fluid tight engagement with an end portion of a respective one of the adjacent hose segments and further configured for fluid flow therethrough; and
a swivel element engaged between said pair of engagement elements configured to permit relative rotation between the engagement elements and defining a passageway therethrough fluidly connecting the adjacent hose segments.

2. The non-kinking fluid delivery hose of claim 1, wherein at least one of the pair of engagement elements is a female element for engagement to the outside of a hose segment.

3. The non-kinking fluid delivery hose of claim 2, wherein the female element is crimped onto the outside of the hose segment.

4. The non-kinking fluid delivery hose of claim 3, the at least one of the pair of engagement elements includes a ferrule inside the hose segment, with the hose segment crimped between the ferrule and the female element.

5. The non-kinking fluid delivery hose of claim 1, wherein at least one of the pair of engagement elements is a male element for engagement to the inside of a hose segment.

6. The non-kinking fluid delivery hose of claim 5, wherein said male element includes a barbed fitting.

7. The non-kinking fluid delivery hose of claim 5, the at least one of the pair of engagement elements includes a ferrule on the outside of the hose segment, with the hose segment crimped between the ferrule and the male element.

8. The non-kinking fluid delivery hose of claim 1, wherein:
the swivel element includes a circumferential groove adjacent a corresponding one of the pair of engagement elements; and
each of the pair of engagement elements includes a circumferential sealing bead in sealed slidable engagement within a corresponding circumferential groove.

9. The non-kinking fluid delivery hose of claim 1, wherein at least one of the hose segments has a length equal to at least the natural coiling diameter of the hose segment.

10. The non-kinking fluid delivery hose of claim 9, in which the fluid delivery hose is a conventional garden hose having a diameter of ½-⅝ inch, wherein the at least one of the hose segments has a length of eighteen (18) inches.

11. The non-kinking fluid delivery hose of claim 1, wherein:
the swivel element includes a pair of circumferential grooves, one each adjacent a corresponding one of the pair of engagement elements; and
one of the pair of engagement elements includes;
a tubular elongated coupling body extending through the swivel element;
a flange defined at one end of the coupling body configured to engage one of the circumferential grooves in said swivel element; and
a washer element configured to engage an opposite end of the coupling body and to seat within the other of the circumferential grooves in said swivel element.

12. The non-kinking fluid delivery hose of claim 11, wherein the opposite end of the coupling body defines a circumferential coupling groove and the washer element is a snap ring configured for snap-fit engagement within the circumferential coupling groove.

13. The non-kinking fluid delivery hose of claim 11, further comprising a wave washer between at least one of said flange and said swivel element, and said washer element and said swivel element.

14. The non-kinking fluid delivery hose of claim 1, wherein said swivel element is formed of a plastic.

15. A non-kinking fluid delivery hose comprising:
a pair of end hose segments at opposite ends of the hose including an end fitting on each of said end hose segments;
a plurality of intermediate hose segments between said end hose segments, each of said intermediate hose segments having a respective end portion and a substantially uniform length among the plurality of hose segments;
a swivel coupling connecting two adjacent ones of said intermediate hose segments, said swivel connector including;
a pair of engagement elements configured for fluid tight engagement with an end portion of a respective one of the adjacent hose segments and further configured for fluid flow therethrough; and
a swivel element engaged between said pair of engagement elements configured to permit relative rotation between the engagement elements and defining a passageway therethrough fluidly connecting the adjacent hose segments.

16. The non-kinking fluid delivery hose of claim 15, wherein each of the pair of engagement elements is a female element for engagement to the outside of a hose segment.

17. The non-kinking fluid delivery hose of claim 16, wherein the female element is crimped onto the outside of the hose segment.

18. The non-kinking fluid delivery hose of claim 15, wherein at least one of the pair of engagement elements is barbed fitting for engagement to the inside of a hose segment.

19. The non-kinking fluid delivery hose of claim 15, wherein each of the intermediate hose segments has a length equal to at least the natural coiling diameter of the hose segment.

20. The non-kinking fluid delivery hose of claim 19, in which the fluid delivery hose is a conventional garden hose having a diameter of ½-⅝ inch, wherein each of the intermediate hose segments has a length of eighteen (18) inches.
